(19) United States
(12) Patent Application Publication
(10) Pub. No.: US 2002/0121825 A1
(43) Pub. Date: Sep. 5, 2002

(54) Motor

(75) Inventor: Rikuro Obara, Nagano-ken (JP)

Correspondence Address: ISRAEL GOPSTEIN, Esq., Suite 200C, 14301 Layhill Rd., P.O. Box 9303, Silver Spring, MD, 20916-9303, US

(73) Assignee: Minebea Kabushiki-kaisha

(21) Appl. No.: 10/087,757

(22) Filed: Mar. 5, 2002

(30) Foreign Application Priority Data
Mar. 5, 2001 (JP) 2001-059902

(51) Int. Cl. H02K 5/16; H02K 7/08

(52) U.S. Cl. 310/90

(57) ABSTRACT

A motor of long life and high precision in its rotation wherein the variation on the rotation and the noises generated thereby are suppressed by maintaining the radial clearance between the components of the bearing device even if the thermal expansion of the components is caused by rising the temperature thereof.

A motor having a rotational member 7 rotatably supported through a bearing device provided on a base member 1 thereof, said bearing device including a shaft 16, a cylindrical outer ring member 17 surrounding the shaft, a plurality of balls of the first and the second rows interposed between the shaft and the outer ring member, and a low expansion member 22 press fit around the outer periphery of the outer ring, wherein the low expansion member is made of a material lower in its coefficient of linear expansion than that employed for the outer ring.

### BACKGROUND OF THE INVENTION

1. Technical Field

The present invention relates to a motor suitable for office automation equipments such as a hard disc drive devil of computers.

2. Description of the prior art

The motor for driving the magnetic disc or discs of the hard disc drive means of computers may have for example the structure in which a pair of single row bearing Price or ball bearings 40 are incorporated as shown in FIG. 35. In FIG. 35, reference numeral 41 denotes a base member including a flange 41a and a stator yoke holder 42, reference numeral 43 denotes a coil or coils, reference numeral 44 denotes a stator yoke or yokes, reference numeral 45 denotes a rotor or a rotational member, reference numeral 46 denotes a central sleeve of the rotor, and reference numeral 47 denotes a rotor magnet or magnets The shaft 48 secured on the base member 41 to extend therefrom is provided with a pair of upper and lower ball bearings 40, 40, and the central sleeve 46 of the rotor 45 or the rotational member is fit over the outer periphery of the ball bearings.

The ball bearing 40 is a bearing of general structure including an inner ring 40a, an outer ring 40b, and plurality of balls 40c interposed thertween. The upper and lower ball bearings include inner rings 40a, 40a adapted to be mounted around the shaft 48, and outer rings 40b, 40b spaced from each other through a spacer 49 interposed therebetween. The reference numeral 40d denotes a ball retainer.

The radial clearance for ac ting the balls is formed between the inner ring raceway and the outer ring raceway. The radial clearance is the amount of the displacement of the outer ring when the outer ring is displaced in the radial direction under the condition that the inner ring is secured on the shaft.

It is necessary to retain the amount of the radial clearance in an optimum value in dependence on the size of the bearing device or the application of the motor, since the radial clearance will greatly affect the service life, the vibration, and the quietness of the bearing device.

However, when the temperature of the bearing device rises under the effect of the frictional heat generated by the rotation or the operation of the bearing device itself or the effect of heat energy supplied from the outside of the bearing device, the components of the bearing device will expand into dimensions which are different from each other. The order of the amount of expansion in the diametral direction of the components is that the outer ring>the inner ring>balls.

There is a following relationship between the radial clearance and the dimension of each components of the bearing (radial clearance)=[inner diameter of the outer ring raceway −(2×diameter of each ball+outer diameter of the inner ring raceway)]

In this connection, upon rising the temperature, the inner diameter of the outer ring raceway will be enlarged to the larger dee than that of the outer diameter of the inner ring raceway formed around the inner ring, and the clearance dined between both ring raceways will also be enlarged. Whereas the degree of enlargement of the balls is small relative to the inner and outer ring raceways so that the radial clearance will be enlarged upon rising the temperature. This will lead to the shortening of the service life of the bearing device. Further the enlargement of the radial clearance will generate the vibration upon rotation and the noise caused thereby. This also deteriorates the precision or the quietness of the rotation of the motors and in some cases, this will result in deterioration of the reliability of the equipment such as the hard disc drive means to which the bearing device is to be incorporated.

Although the balls are usually made from steel material, ceramic material may also be used for enhancing the durability thereof. In such a case, the above mentioned problem caused by the difference of the amount of thermal expansion between components will become serious, since the amount of thermal expansion of the ceramic material is further lower (about 1/10) than that of the iron material used for the inner and outer rings.

Accordingly the object of the present invention is to provide a motor including a bearing device wherein an optimum radial clearance can be maintained even if the components thereof expand upon rising the temperature thereof. In other words, the object of the present invention is to provide a motor including a bearing device of high precision in its rotation and long life wherein the vibration upon rotation of the bearing and the noise caused thereby ate difficult to

### SUMMARY OF THE INVENTION

In order to attain the object of the present invention, a motor in accordance with the first as- of the present invention is a motor having a rotational member rotatably rotatably supported through a bearing device provided on a base member of the motor, said bearing device including an inner and an outer rings and a plurality of balls interposed therebetween, the bearing device further includes a low expansion member press fit around the outer periphery of the outer ring, wherein the low expansion member is made of a material lower in its coefficient of linear expansion than that employed for the outer ring.

A motor in accordance with the second aspect of the present invention is a motor having a rotational member rotatably supported through a bearing device provided on a base member thereof, said bearing device further including a shaft, a cylindrical outer ring member surrounding the shafts a plurality of balls of the first and the second rows interposed between the shaft and the outer ring member, and a low expansion member press fit around the outer periphery of the outer ring, wherein the low expansion member is made of a material lower in its coefficient of linear expansion than that employed for the outer ring.

A motor in accordance with he third aspect of the present invention is a motor having a rotational member rotatably supported through a bearing deice provided on a base member thereof, said bearing device further including a shaft to which an inner ring is fit slidably therearound, a cylindrical outer ring member surrounding the shaft, a plurality of balls of the first row interposed between the first inner ring raceway formed on the outer periphery of the inner ring and the first outer ring raceway formed on the inner periphery of the outer ring Or, a plurality of balls of the second row interposed between the second inner ring raceway formed directly on the outer periphery of the shaft and the second outer ring raceway formed on the inner periphery of the outer ring member, and a low mansion ring press fit around the outer periphery of the outer ring, wherein the low mansion ring is made of a material lower in its coefficient of linear expansion than that employed for the outer ring, the inner ring is secured on the shaft with plying an appropriate amount of preload thereon.

A motor in accordance with the fourth aspect of the present invention is a motor having a rotational member rotatably supported through a bearing device provided on a base member thereof, said bearing device further including a shaft, a cylindrical outer ring member surrounding the shaft, a plurality of balls of the first and the second rows interposed between the shaft and the outer ring member, and a low expansion member press fit around the outer periphery of the outer ring, wherein the low expansion member is made of a material lower in its coefficient of linear expansion than that employed for the outer ring, and wherein the shaft is secured on the base member to extend therefrom, and the central portion of the rotor or the rotational member is fit over the outer periphery of the outer ring member.

A motor in accordance with the fifth aspect of the present invention is a motor having a rotational member rotatably supported through a bearing device provided on a base member thereof, said bearing device further including a shaft to which an inner ring is fit slidably therearound, a cylindrical outer ring member surrounding the shaft, a plurality of balls of the first row interposed between the first inner ring raceway formed on the outer periphery of the inner ring and the first outer ring raceway formed on the inner periphery of the outer ring member, a plurality of balls of the second row interposed between the second inner ring raceway formed directly on the outer periphery of the shaft and the second outer ring raceway formed on the inner periphery of the outer ring member, and a low expansion ring press fit around the outer periphery of the outer ring, wherein the low expansion ring is made of a material lower in its coefficient of linear expansion than that employed for the outer ring, the inner ring is secured on the shaft with applying an appropriate amount of preload thereon, and wherein the shaft is secured on the base member to extend therefrom, and the central portion of the rotor or the rotational member is fit over the outer periphery of the outer ring member.

The balls are preferably of ceramic material, and the low expansion member is preferably also of ceramic material.

### BRIEF DESCRIPTION OF THE DRAWINGS

Further feature of the present invention will become apparent to those skilled in the art to which the present invention relates from reading the following specification with reference to the accompanying drawings, in which:

FIG. 1 is a longitudinal sectional view showing the motor of the first embodiment in accordance with the present invention;

FIG. 2 is a longitudinal sectional view showing the bearing device of the motor shown in FIG. 1;

FIG. 3 is a longitudinal sectional view showing the motor of the second embodiment in accordance with the present invention;

FIG. 4 is a longitudinal sectional view showing the bearing device of the motor shown in FIG. 3;

FIG. 5 is a longitudinal sectional view showing the motor of the third embodiment in accordance with the present invention;

FIG. 6 is a longitudinal sectional view showing the bearing device of the motor shown in FIG. 5;

FIG. 7 is a longitudinal sectional view showing the motor of the fourth embodiment in accordance with the present invention;

FIG. 8 is a longitudinal sectional view showing the bearing device of the motor shown in FIG. 7;

FIG. 9 is a longitudinal sectional view showing the motor of the fifth embodiment in accordance with the present invention;

FIG. 10 is a longitudinal sectional view showing the bearing device of the motor shown in FIG. 9;

FIG. 11 is a longitudinal sectional view showing the motor of the sixth embodiment in accordance with the present invention;

FIG. 12 is a longitudinal sectional view showing the bearing device of the motor shown in FIG. 11;

FIG. 13 is a longitudinal sectional view showing the motor of the seventh embodiment in accordance with the present invention;

FIG. 14 is a longitudinal sectional view showing the bearing device of the motor shown in FIG. 13;

FIG. 15 is a longitudinal sectional view showing the motor of the eighth embodiment in accordance with the present invention;

FIG. 16 is a longitudinal sectional view showing the bearing device of the motor shown in FIG. 15;

FIG. 17 is a longitudinal sectional view showing the motor of the ninth embodiment in accordance with the present invention;

FIG. 18 is a longitudinal sectional view showing the bearing device of the motor shown in FIG. 17;

FIG. 19 is a longitudinal sectional view showing the motor of the tenth embodiment in accordance with the present invention,

FIG. 20 is a longitudinal sectional view showing the bearing device of the motor shown in FIG. 19;

FIG. 21 is a longitudinal sectional view showing the motor of the eleventh embodiment in accordance with the present invention;

FIG. 22 is a longitudinal sectional view showing the bearing device of the motor shown in FIG. 21;

FIG. 23 is a longitudinal sectional view showing the motor of the twelfth embodiment in accordance with the present invention;

FIG. 24 is a longitudinal sectional view showing the bearing device of the motor shown in FIG. 23;

FIG. 25 is a longitudinal sectional view showing the motor of the thirteenth embodiment in accordance with the present invention;

FIG. 26 is a longitudinal sectional view showing the bearing device of the motor shown in FIG. 25;

FIG. 27 is a longitudinal sectional view showing the motor of the fourteenth embodiment in accordance with the present invention;

FIG. 28 is a longitudinal sectional view showing the bearing device the motor shown in FIG. 27;

FIG. 29 is a longitudinal sectional view showing the motor of the fifteenth embodiment in accordance with the present invention;

FIG. 30 is a longitudinal sectional view showing the bearing device of the motor shown in FIG. 29;

FIG. 31 is a longitudinal sectional view showing the motor of the sixteenth embodiment in accordance with the present invention;

FIG. 32 is a longitudinal sectional view showing the bearing device of the motor shown in FIG. 31;

FIG. 33 is a longitudinal sectional view showing the motor of the seventeenth embodiment in accordance with the present invention;

FIG. 34 is a longitudinal sectional view showing the bearing device of the motor shown in FIG. 33;

FIG. 35 is a longitudinal sectional view showing the motor of the prior art; and

FIG. 36 is an enlarged longitudinal sectional view showing the bearing device shown in FIG. 35.

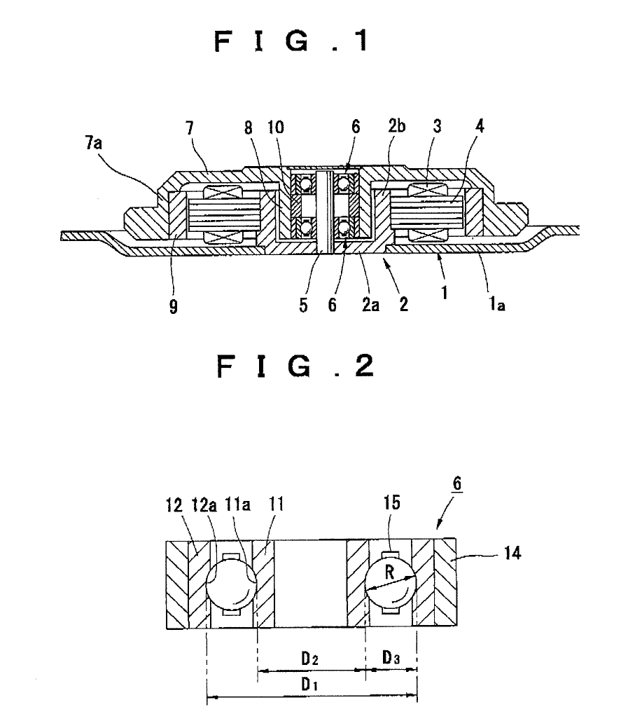

### DETAILED DESCRIPTION OF THE PRESENT INVENTION

Motors in accordance with various embodiments of the present invention will now be described in detail on the basis of the concrete examples thereof illustrated in the attached drawings.

A motor in accordance with the first embodiment of the present invention includes as shown in FIG. 1, a base member including a flange 1a and a stator yoke holder 2 attached to the central portion of the flange The stator yoke holder 2 includes a bottom plate 2a and a cylindrical rib 2b formed integrally around the outer periphery of the bottom plate with the same material as that of the bottom plate. The cylindrical rib 2b is provided around the outer periphery thereof with stator yokes 4 around which coils 3 for energizing the motor are wound.

A shaft 5 is fixedly secured on the central portion of the bottom plate 2a of the stator yoke holder 2 to extend upwardly therefrom. A rotor 7 including a slew 9 formed integrally therewith by employing the same material as that of the rotor is fit around the outer periphery of the upper and lower ball bearing device 6, 6 mounted around the shaft 5. The rotor 7 or the rotational member of the motor can thus be rotatably supported through the bearing dee with respect to the base member 1.

A flange 7a formed around the outer peripheral portion of the rotor 7 is provided on its inner periphery with magnets 9 so as to face with the outer periphery of the stator yoke with remaining a slight clearance between them.

The element of the ball bearing device to which reference numeral 10 is a is a spacer interposed beg the per and lower ball bearing deice 6, 6.

The ball beating 6 or bearing device includes an inner and an outer rings 11 and 12, a plurality of balls 13 of steel or ceramic material interposed between an inner ring raceway 11a formed on an outer peripheral surface of the inner ring 11 and an outer ring raceway 12a formed on an inner peripheral surface of the outer ring 12, and a low expansion ring 14 press fit around the outer periphery of the outer ring 12. The low expansion ring 14 is formed of a material of lower coefficient of linear expansion than that employed in the outer ring.

The inner and outer rings 11 and 12 are formed of iron material such as high carbon chromium bearing steel or stainless steel. Preferably the low expansion ring 14 is formed of a ceramic material of lower coefficient of linear expansion than iron material. The ratio of the coefficient of linear expansion of the ceramic material to that of the iron material is 1/1.5-1/3. The element of the ball bearing device to which reference numeral 15 is added is a ball retainer.

Upon rising the temperature of the bearing device or each element thereof under the effect of the frictional heat generated by the rotation or the operation of the motor or the effect of beat energy supplied from the outside of the motor, the thermal expansion of the elements of the bearing device will occur . However, the tendency of expansion of the outer race 12 is restrained by the low expansion ring 14 press fit therearound, so that the amount of the expansion of the inner diameter of the outer ring raceway 12a is also suppressed.

The amount of expansion of the inner diameter D₁ of the outer ring raceway 12a of the outer ring 12 can be constrained substantially equal to the amount of expansion of the outer diameter D₂ of the inner ring raceway 11a of the inner ring 11 by setting the pressure to be applied on the outer ring by means of the low expansion ring 14 to any suitable value. Thus the spacing D₃ between the outer ring raceway 12a and the inner ring raceway 11a can be maintained substantially constant value, i.e. the radial clearance can be maintained constantly in an appropriate value, so that the stable rotation of the bearing device can be obtained.

Although the above-mentioned motor of the first embodiment employs as the bearing device a pair of ball bearings of the single row type, the motor of the present invention can also include a compound bearing device including two parallel rows of balls. The embodiments (the second to seventeenth embodiments) of the compound bearing will now be described as follows,

In the following description, the structure of each motor of the respective embodiment is not included since they are substantially identical with each other except for the structure of the bearing device.

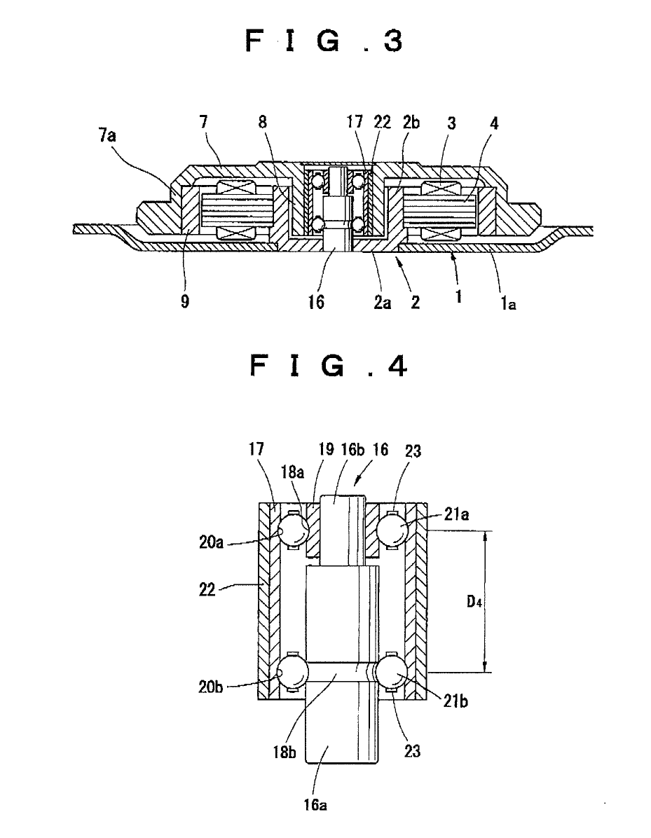

The bearing device of the motor of the second embodiment in accordance with the present invention comprises as shown in FIGS. 3, 4, a stepped shaft 16 including a larger diameter shaft portion 16a and a reduced diameter shaft portion 16b, a sleeve outer ring or outer ring member 17 surrounding the stepped shaft, an inner ring 19 fit around the reduced diameter shaft portion 16b of the stepped shaft. The outer periphery of the inner ring 19 is provided with a first inner ring raceway 18a as an annular groove, and the outer periphery of the larger diameter shaft portion 16a is provided directly with a second inner ring raceway 16b as an annular groove.

The outer ring 17 includes upper and lower portions on the inner periphery of which is provided directly with a pair of parallel first and the second outer ring raceways 20a and 20b respectively as grooves and a central portion disposed between the upper and lower portions. The sleeve outer ring 17 is adapted to serve as an outer ring in common with both of two rows of balls. A plurality of balls 21a of the first row are interposed between the first outer ring raceway 20a and the first inner ring raceway 18a, and a plurality of balls 21b of the second row are interposed between the second outer ring raceway 20b and the second inner ring raceway 18a.

The balls 21a and 21b are made for example of steel or ceramic material and equal in their diameter. This is because the outer diameter of the inner ring 19 is the same as that of the larger diameter shaft portion 16a of the stepped shaft.

A low expansion sleeve 22 or the low expansion number made of a material of lower coefficient of linear expansion than the material employed for the sleeve outer ring 17 is press fit around he outer periphery of the sleeve outer ring 17. The low expansion ring 12 is for Parable of ceramic material.

The low expansion sleeve 22 is a straight cylindrical member, and each of the inner and outer diameters of which is identical over the axial direction thereof. The low expansion member is adapted to intimately join on its inner peripheral surface over the entire surface of the outer periphery of the sleeve outer ring.

The element of the ball bearing device to which reference numeral 23 is added is a ball retainer.

In the bearing device of the second embodiment, upon rising the temperature of the bearing device under the effect of the frictional heat generated by the rotation or the operation of the bearing device itself or the effect of heat energy supplied from the outside thereof, the thermal expansion of the components of the bearing device will also occur in the same manner as the bearing device of the above mentioned first embodiment. However, the expansion of the sleeve outer ring 17 in the diametral direction is constrained under the effect of the low expansion member 22 press fit therearound, i.e. the amount of expansion of the inner diameter of the outer ring raceways 20a, 20b of the sleeve outer ring can be restrain in substantially the same value as the amount of expansion of the outer diameter of the first and the second inner ring raceways 18a, 18b by setting the pressure to be applied by the low expansion member 22 on the sleeve outer ring in a suitable value. Thus the spacing between the corresponding inner and the outer ring raceways can be maintained in a substantially constant value.

The sleeve outer ring 17 tends to extend axially upon rising the temperature through the thermal expansion thereof. The amount of extension of the sleeve outer ring 17 under constraint is larger than the case in which the ring is expanded freely. This is because the amount of the expansion of the ring constrained by the low expansion member 22 in the diametral direction is transferred into the extension of the sleeve outer ring.

The axial extension of the sleeve outer ring 17 will lead to the enlargement of the spacing Do between the first and the second outer ring raceways 20a and 20b. In other words, the outer ring raceways will displace relative to the balls to reduce the radial clearance defined therebetween.

Thus the radial clearance can be maintained in an appropriate value even if the temperature rises, and stable rotation of the bearing device can be obtained.

In the compound bearing device of the motor of the second embodiment, the inner ring 19 is adapted to be fixedly secured around the shaft with applying an appropriate pre-load thereon, when the bearing device is manufactured. Thus, the compound bearing ice of the complete form in which an appropriate pre-load have been applied can be incorporated, the assailing operation of the motor is to be made.

In the above mentioned bearing device of the motor of the second embodiment, the sleeve outer ring 17 is serves as an outer ring in common with both of the upper and the lower rows so that the number of parts can be reduced, the diameter of the layer diameter shaft portion 16a can be enlarged by the thicknesses of the outer ring of the ball bearing, and the diameter of the reduced diameter shaft portion 16b can also be enlarged by the thickness of the outer ring of the ball bearing, i.e. generally thick steed shaft 16 can be obtained.

Accordingly, the stepped shaft 16 of higher rigidity, good at durability, inhibited in its rotational run out, and good at quietness can be obtained. Thus the motor of higher durability and precision of rotation can be obtained.

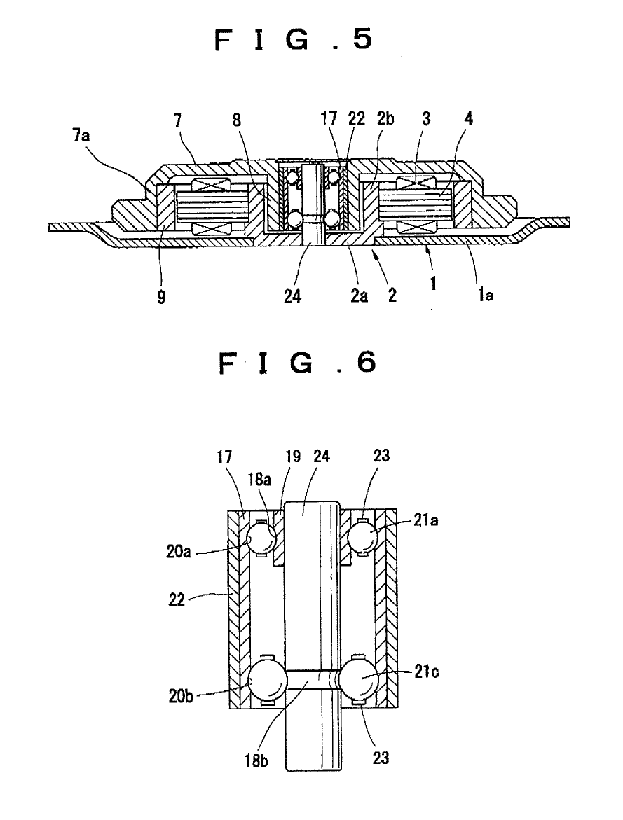

In the bearing device of the motor of the above mentioned second embodiment, although the shaft is formed as the stepper shaft 16, the shaft can be a straight one 24 as that of the third embodiment as shown in FIGS. 5, 6.

The bearing device of the motor of the third embodiment is also provided with the inner ring 19 on the first row of balls 21a (i.e. the upper side in FIGS. 5, 6). whereas no inner ring is provided on the second raw of balls 21c (i.e. the lower side in FIGS. 5, 6), and the second inner ring raceway 18b is formed directly on the outer peripheral surface of the straight shaft 24.

Thus the balls 21c of the second row are larger in their diameter than that of the balls 21a of the first row.

The general structure of the bearing device of the motor of the third embodiment is substantially identical with that of the second embodiment except for the arrangement of the shaft and the balls of the second row.

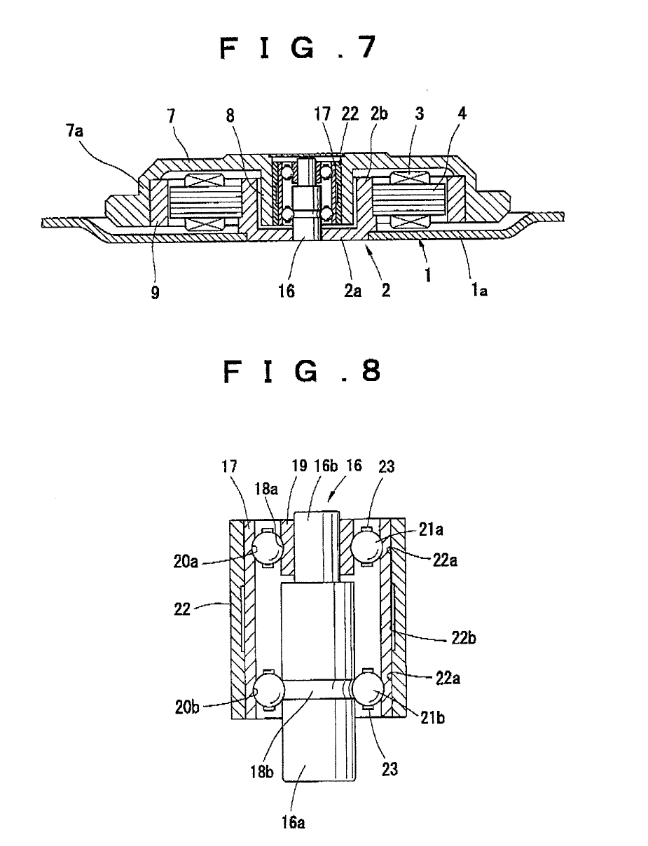

In the bearing device of the motor of each of the second and the third embodiments, the low expansion sleeve 22 or low expansion member is a straight cylindrical member. Whereas the low expansion sleeve including the upper and the lower reduced inner diameter portions 22a, 22a and the thin walled larger inner diameter portion 22b interposed Between can also be used as each of the fourth and the fifth embodiments as illustrated in FIGS. 7, 8 and 9, 10 respectively. In such cases, the outer peripheral surfaces of the upper and the lower portions of the sleeve outer ring on the inner peripheral surface of which is provided with the first and the second outer ring raceways 20a, 20b are pressed inwardly by means of the reduced inner diameter portion 22a, 22a.

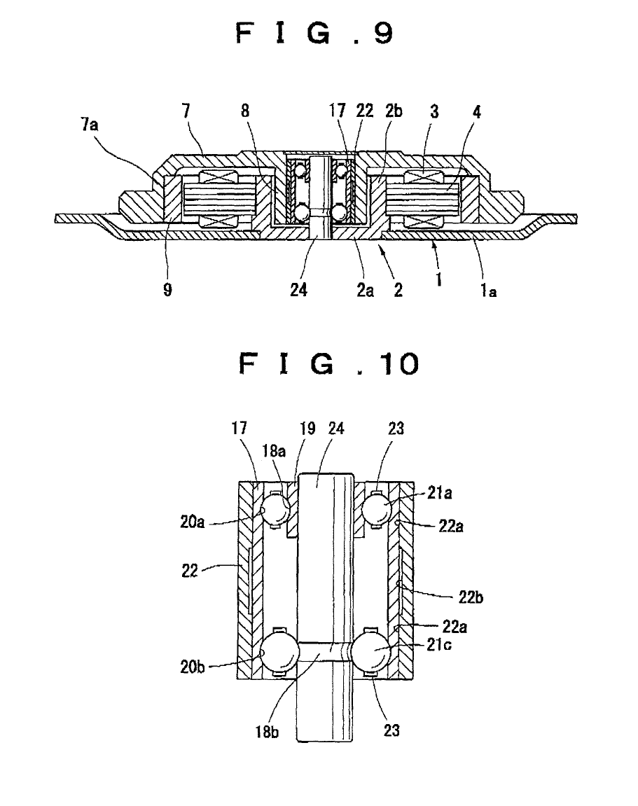

The bearing device of the fifth embodiment as shown in FIGS. 9, 10 is arranged to substitute a straight shaft 24 for the stepped shaft 16 of the fourth embodiment as shown in FIGS. 7, 8, and the components or arrangements other than the shaft and the balls of the second row are identical with those of the fourth embodiment.

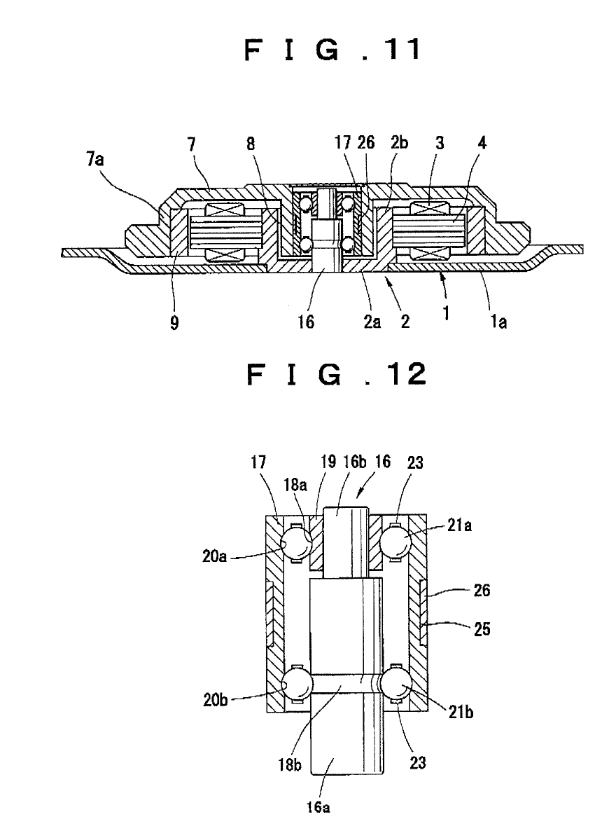

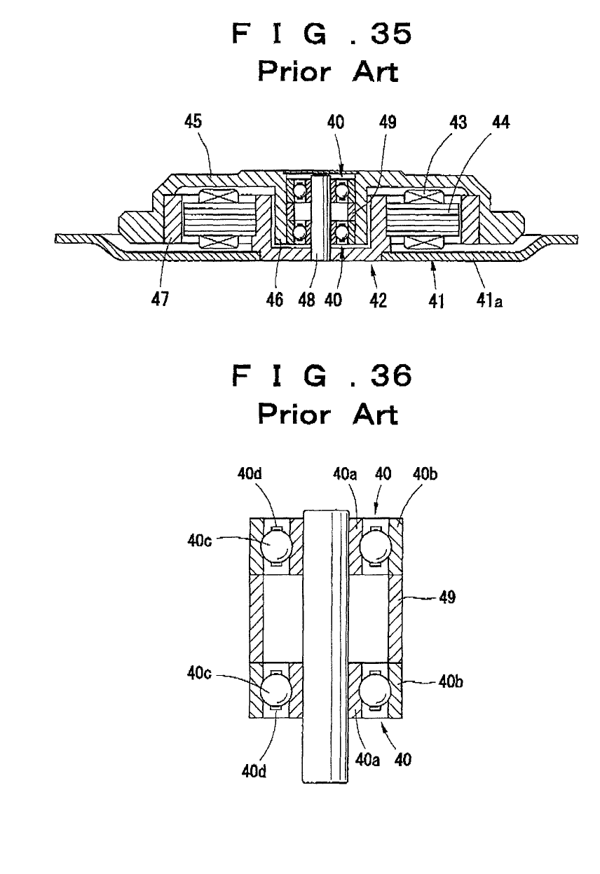

In the bearing device of the motor of each of the second to the fifth embodiments, the sleeve outer ring 17 or the outer ring member is adapted to be surrounded entirely over the outer periphery thereof by means of the low expansion sleeve 22. Whereas a short cylindrical low expansion ring can also be used to surround a portion of the outer ring member as those of the sixth to the nineteenth embodiment illustrated in FIGS. 11-38. Further, the outer ring mater and/or the low expansion ring may also be formed by a pair of upper and lower rings rather than the one ring. These embodiments will now be described concretely as follows.

In the bearing device of the motors in accordance with the sixth and the seventh embodiments shown in FIGS. 11, 12 and 13, 14, the sleeve outer ring 17 includes upper and lower portions and a central portion between them. The upper and the lower portions are provided on their inner peripheral surface with the first and the second outer ring raceways 20a and 20b respectively. The central portion is provided on the outer periphery thereof with a reduced outer diameter portion 25 to for a thin wall. A low expansion ring 26 or a low expansion member is press fit around the reduced outer diameter portion 25.

The outer diameter of the low expansion ring 26 is the same as that of the upper and lower portions of the sleeve outer ring 17, so that the bearing device of straight configuration and having substantially constant diameter can be obtained.

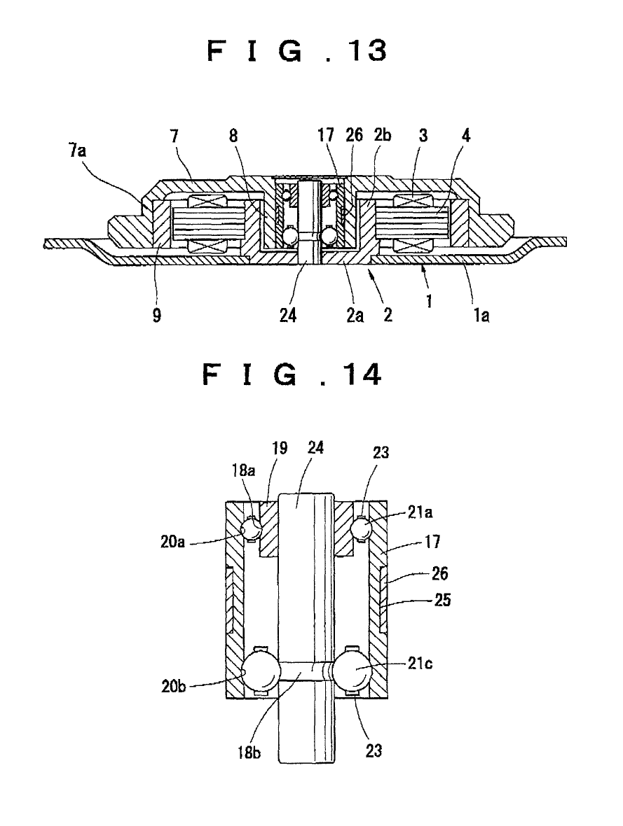

The bearing device of the seventh embodiment as shown in FIGS. 13, 14 is arranged to substitute a straight shaft 24 for the stepped shaft 16 of the sixth embodiment as shown in FIGS. 11, 12, and the components or arrangements other than the shaft and the balls of the second row are identical with those of the sixth embodiment.

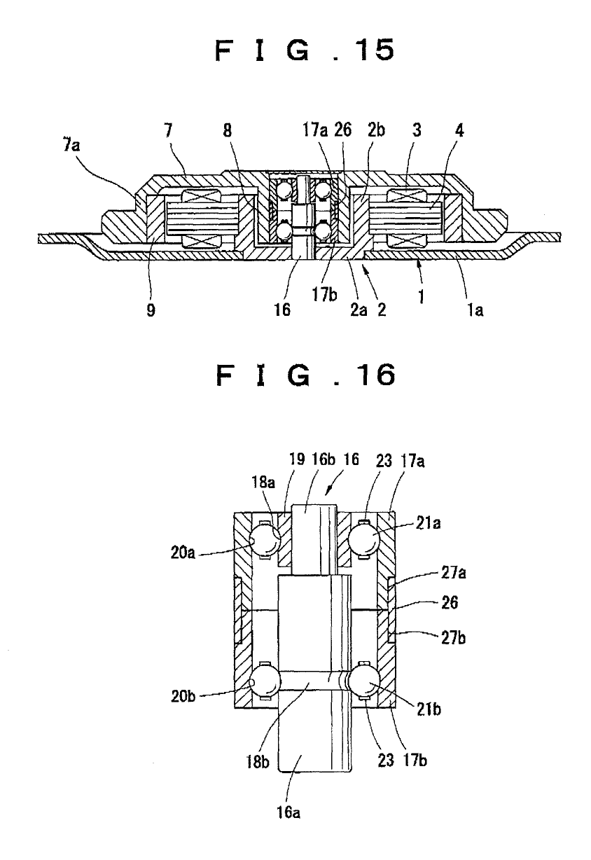

Although in the above mentioned the sixth and the seventh embodiments, two rows of outer ring raceways 20a and 20b are formed on the inner surface of the sleeve outer ring 17, the sleeve outer ring can be formed by a pair of first and second sleeve outer ring 17a, 17b such as those of the eighth to the eleventh embodiments as shown in FIGS. 15-22.

In the bearing device of the motor of each of the eighth and the ninth embodiments, each of the first and the second sleeve outer rings 17a and 17b is formed with reduced outer diameter steeped portions 27a, 27b respectively on their ends opposed with each other. The end faces of these reduced outer diameter stepped portions are machined in high precision so as to contact intimately with each other. A low expansion ring 26 is adapted to be press fit around the outer periphery of the reduced outer diameter stepped portions 27a, 27b.

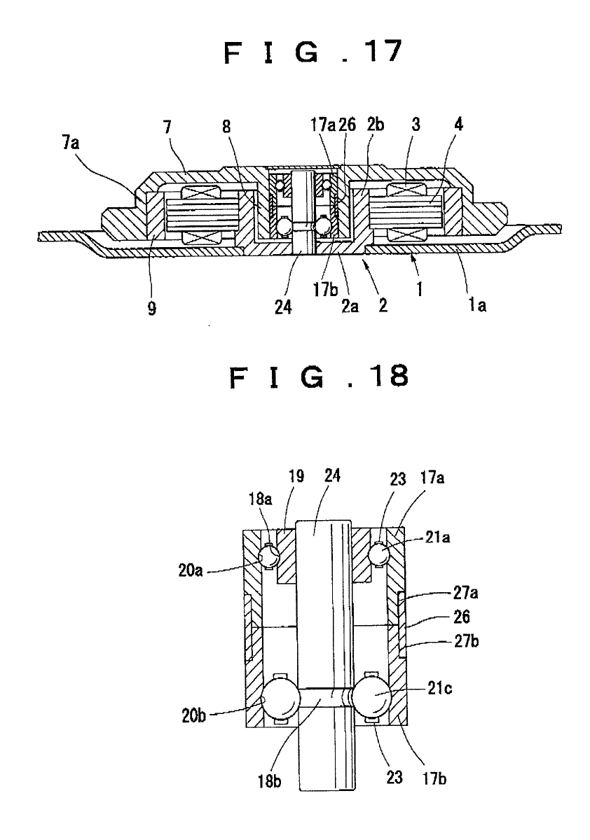

The bearing device of the ninth embodiment as shown in FIGS. 17, 18 is arranged to substitute a straight shaft 24 for the stepped shaft 16 of the eighth embodiment as shown in FIGS. 15, 16, and the components or arrangements other than the shaft and the balls of the second row are identical with those of the eighth embodiment.

In the tenth and the eleventh embodiments, each of the first and the second sleeve outer rings 17a and 17b is formed with reduced outer diameter stepped portions 27a, 27b respectively on their ends opposed with each other. The end faces of these reduced outer diameter stepped portions are machined in high precision so as to contact intimately with each other. Each of the first and the second low expansion rings 26a, 26b is adapted to be press fit respectively around the outer periphery of each of the reduced outer diameter portions 27a, 27b.

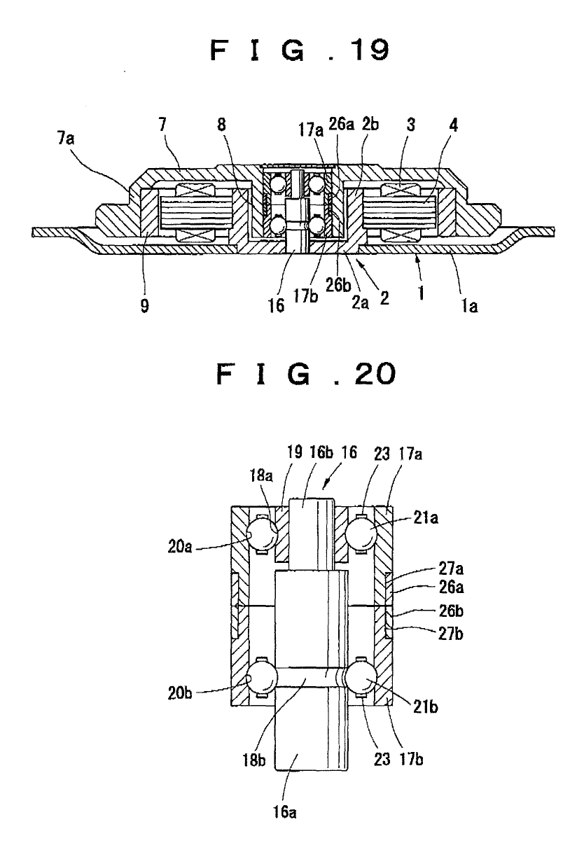

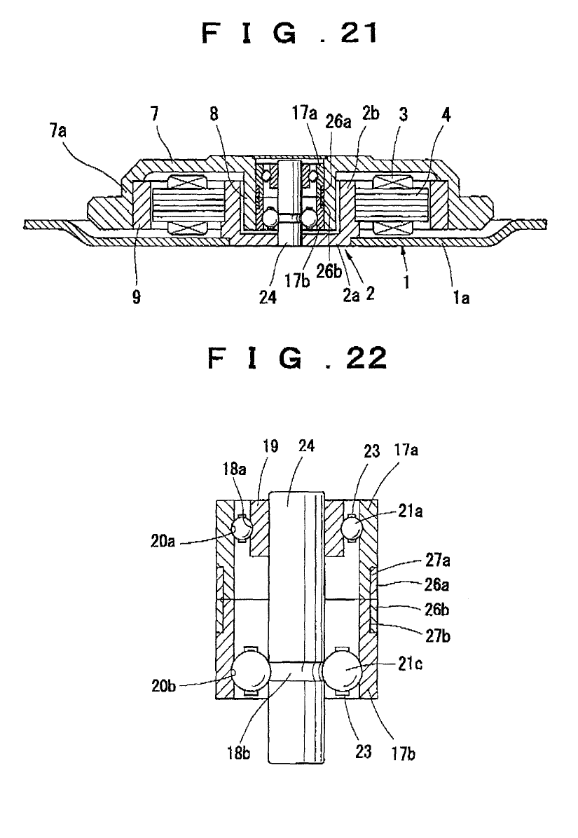

The bearing device of the motor of the eleventh embodiment as shown in FIGS. 21, 22 is arranged to substitute a straight shaft 24 for the stepped shaft 16 of the tenth embodiment as shown in FIGS. 19, 20 and the components or arrangements other than the shaft and the balls of the second row are identical with those of the tenth embodiment.

In the bearing device of the motor of each of the eighth to the eleventh embodiments, the press fitting operation of the low expansion ring or the rings around the reduced outer diameter portions of the sleeve outer ring can be effected easier, since the sleeve outer rings of these embodiments can be divided or separated into the upper and lower outer rings.

In the bearing device of the above described the second to the seventh embodiments, the sleeve outer ring 7 serving as one common outer ring member is provided with a pair of outer ring raceways thereon. In this connection, it is difficult to machine these two outer ring raceways with assuring the concentricity and/or the parallelism between the raceways in high precision. This machining operation is particularly difficult where the balls of the first row are spaced relatively larger from those of the second row. Whereas in the bearing device of the eighth to the eleventh embodiments, the operation for machining the outer ring raceways in high precision can relatively easily be carried out. This is because the sleeve outer ring is divided into two sleeve outer rings 17a, 17b, and the machining operation might be carried out in each of these sleeve outer rings. In other words, the machining operation of the ring raceways can easily he effected in high precision. This will bring the great advantage that the raceways can easily be machined in high precision even if the spacing between the balls of the first row and those of the second row is relatively large.

In the bearing device of the motor of each of the sixth to eleventh embodiments, the low expansion ring 26 or rings 26a and 26b are adapted to be provided around the outer periphery of the central portion of the sleeve outer ring 17 or opposite end portions of the rings 17a and 17b. In such a structure, the dimension of the radial clearance can be maintained even if the temperature is risen, by increasing the pressure to be applied by the low expansion ring or rings on the sleeve outer ring or rings to deform the sleeve outer ring or rings, and to reduce the diameter of each of the first and the second outer ring raceways as well as the longitudinal spacing between the raceways. This is particularly advantageous in the case that the coefficient of linear expansion of the low expansion ring is substantially identical with that of the sleeve outer ring.

Setting forth in more detail, upon reducing the diameter of the sleeve outer ring by increasing the pressure applied by the low expansion ring, also reduced is the spacing between the first and the second outer ring raceways 20a, 20b. The sleeve outer ring, balls, and inner ring are assembled with the shaft under such condition. In such a condition, the inner ring is mounted around the shaft with applying an appropriate pre-load.

In the bearing device assembled in the manner as mentioned above, the low expansion ring will expand outwardly upon rising the temperature of the bearing device, and the sleeve outer ring being constrained in its diameter by the low expansion ring will also expand in both of the radial and the longitudinal directions under the effect of elastic recovering force. Accordingly, the spacing between the first and the second outer ring raceways are enlarged so that both outer ring race ways will displace so as to reduce the radial clearance defined between each race ways and corresponding balls. In conclusion, the radial clearance can be maintained in a normal range of value, and thus steady rotation can also be obtained.

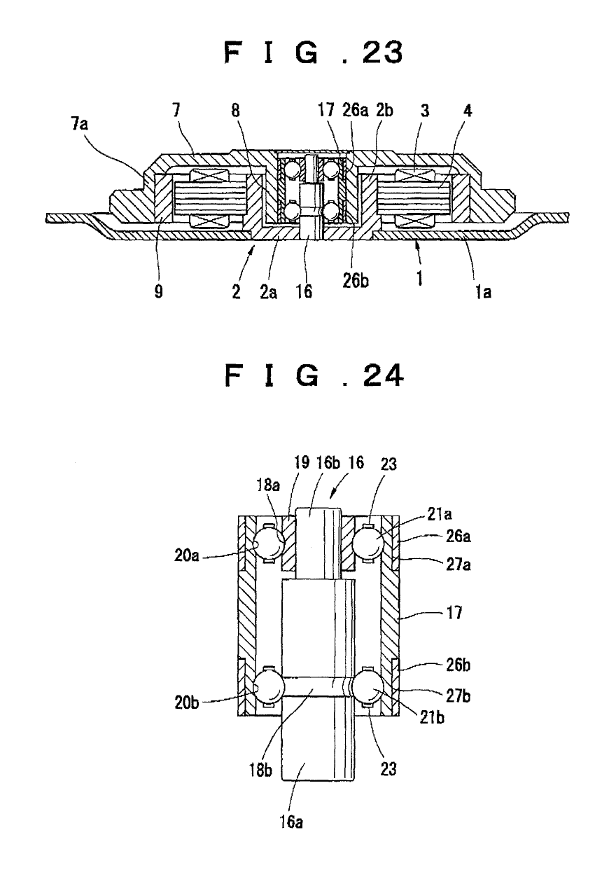

On the contrary to the bearing device of the motors of the second to eleventh embodiments in which the low expansion member is or members are adapted to be provided around the central portion of the sleeve outer ring, thin walled reduced outer diameter stepped portions 27a and 27b can be formed respectively around the opposite ends of the upper and lower portions of the sleeve outer ring 17 as in the case of the twelfth and the thirteenth embodiments as shown in FIGS. 23, 24 and 25, 26. In such a case, the low expansion rings 26a, 26b may be press fit therearound.

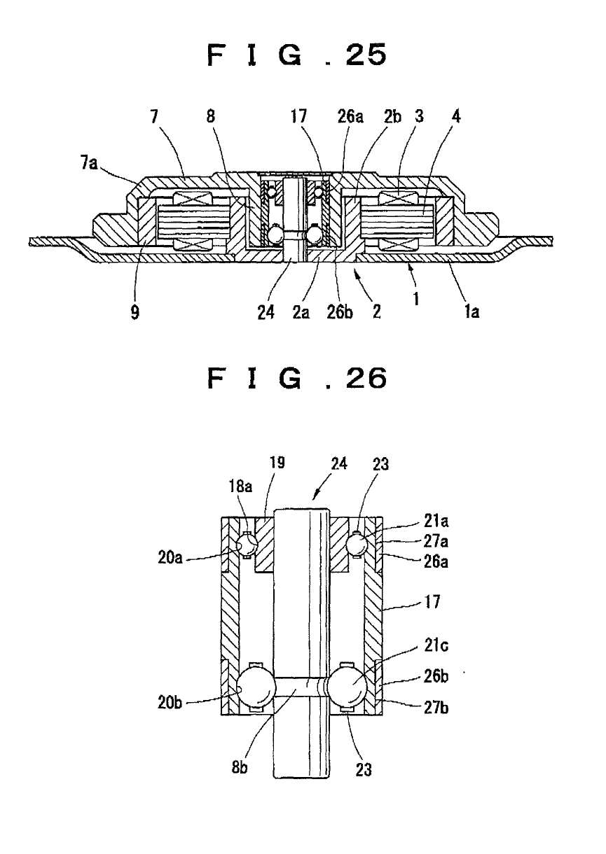

The bearing deice of the motor of the thirteenth embodiment as shown in FIGS. 25, 26 is arranged to substitute a straight shaft 24 for the stepped shaft 16 of the twelfth embodiment as shown in FIGS. 23, 24, and the Components or arrangements other than the shaft and the balls of the second row are identical with those of the twelfth embodiment.

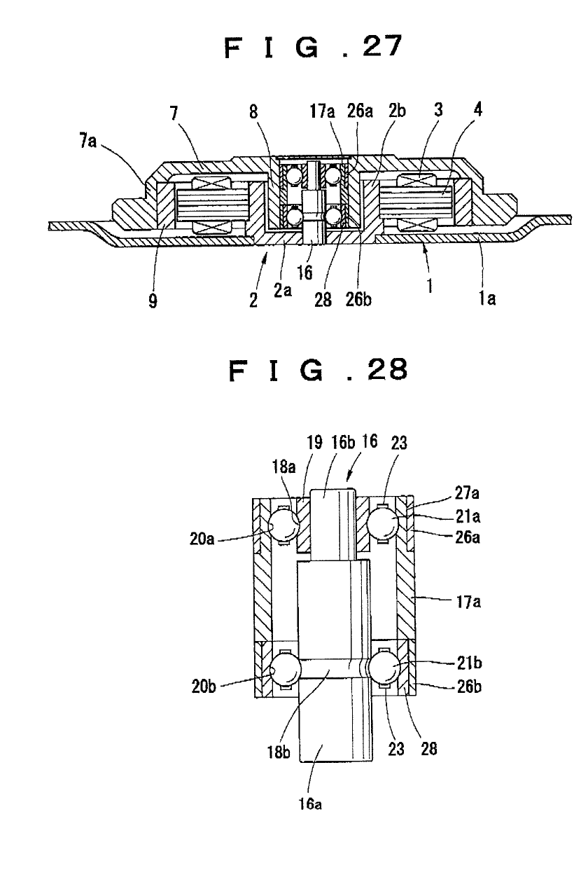

The bearing device of the motor of each of the fourteenth and the fifteenth embodiments as shown in FIGS. 27, 28 and 29, 30 include a sleeve outer ring 17a having the first outer ring raceway 20a on its inner peripheral surface on the side of the first row of balls 21a and an independent short outer ring 28 having the second outer ring raceway 20b on its inner peripheral surface on the side of the second row of balls 20b. The outer ring member is formed by the sleeve outer ring 17a and the independent outer ring 28.

The first outer ring raceway 20a is formed on the inner periphery of the upper portion of the sleeve outer ring 17a around the outer peripheral surface of which a reduced outer diameter stepped portion 27a is formed. The first low expansion ring 26a is adapted to be press fit over the outer periphery of the reduced outer dieter stepped portion. The second low expansion ring 26b is press fit over the outer periphery of the independent outer ring 28.

The end faces of the sleeve outer ring 17a and the independent outer ring 28 opposed with each other are machined in high precision so as to contact intimately with each other. The outer diameter of the independent outer ring 28 is the same as that of the reduced outer diameter stepped portion 27a of the sleeve outer ring 17a. The first and the second low expansion rings 26a and 26b are equal in their inner and outer diameter. Thus the bearing device having a substantially straight outer peripheral surface equal in the diameter in the axial direction can be obtained.

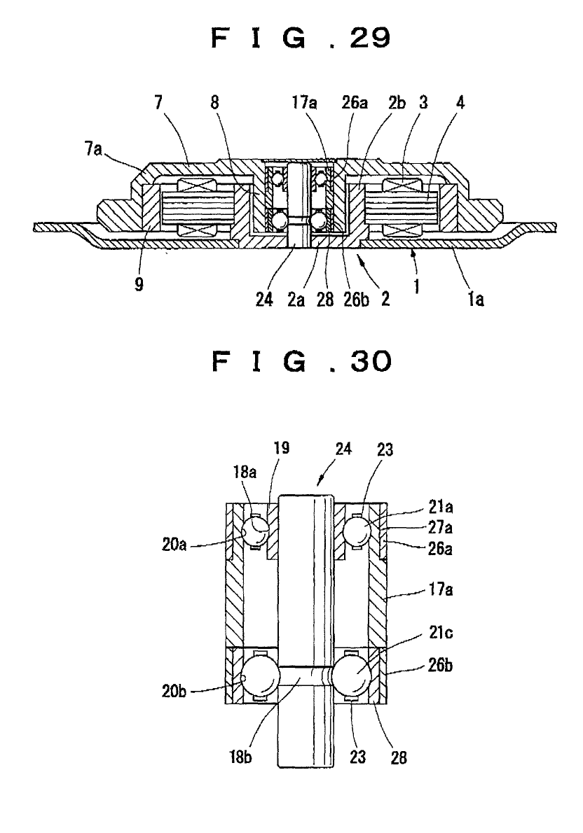

The bearing device of the motor of the fifteenth embodiment as shown in FIGS. 29, 30 is arranged to substitute a straight shaft 24 for the stepped shaft 16 of the fourteenth embodiment as shown in FIGS. 27, 28, and the components or arrangements other than the shaft and the balls of the second row are identical with those of the fourteenth embodiment.

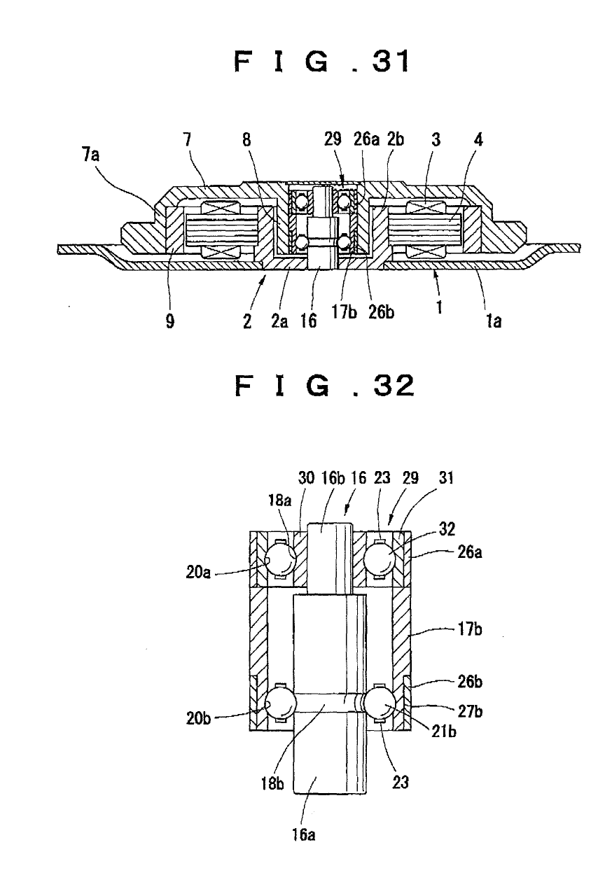

The bearing device of the motor of each of the sixteenth and seventeenth embodiments as shown in FIGS. 31-34 is adapted to use a ball bearing 29 of the single row type in one of the ball rows. The ball bearing 29 includes inner and outer rings 30 and 31, a plurality of balls 32 of ceramic material interposed therebetween, and the first low expansion ring 26a press fit around the outer periphery of the outer ring 31.

In the motor of each of the sixteenth and the seventeenth comments as shown in FIGS. 31, 32 and 33, 34 respectively, at the side of the other row of balls 21b, the second outer ring raceway 20b is formed on the inner periphery of the lower portion of the sleeve outer ring 17b. The outer peripheral surface of the outer ring 17b is provided with a reduced outer diameter stepped portion 27b. The second low expansion ring 26b is press fit over the outer peripheral surface of the reduced outer diameter stepped portion 27b. The outer ring member is formed by the combination of the sleeve outer ring 17b and the outer ring 31 of the ball bearing.

The end faces of the outer ring 31 of the ball bearing and the sleeve outer ring 17b opposite with each other are machined in high precision so as to contact intimately with each other. The outer diameter of the outer ring 31 is the same as that of the reduced outer diameter stepped portion 27b of the sleeve outer ring 17b. The first and the second low expansion rings 26a and 26b are equal in their inner and outer diameter. Thus the bearing device having a substantially straight outer peripheral surface equal in the diameter in the axial direction can be obtained.

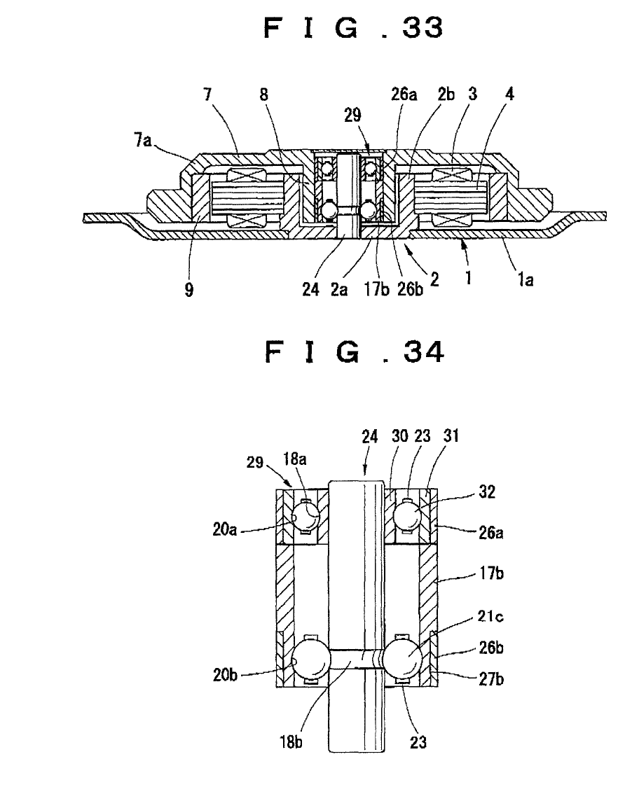

The bearing device of the motor of the seventeenth embodiment as shown in FIG. 33, 34 is arranged to substitute a straight shaft 24 for the stepped shaft 16 of the sixteenth embodiment as shown in FIG. 31, 32, and the components or arrangements other than the shaft and the balls of the second row are identical with those of the sixteenth embodiment.

The bearing device of the above-mentioned embodiments has a straight configuration equal in its outer diameter over the length thereof so that the bearing device can be assembled into the vertical bore of the rotor or the rotational member of a motor to which the bearing devil is to be incorporated such as a rotor hub, without rearing a special machining process such as making any steps on the inner surface of the vertical bore of the rotational member.

The motors of all above-mentioned embodiments are of the outer rotor type in which the shaft of the motor is fixedly secured. However, the motor of shaft rotating type in which the sleeve outer ring or the outer ring member of the compound bearing device is connected to the base member, and the rotating member is connected to the shaft can also be used. Further, a motor of the inner rotor type in which the rotor magnets are provided on the inside of the stator yoke can also be used.

The motor of the arrangement or the structure as described above in accordance with the present invention will provide the following effects or advantages.

The diametric expansion of the outer ring member is constrained by the low expansion ring even if the thermal expansion of the components of the bearing device will be caused upon rising the temperature of the bearing device, since the low expansion ring is formed of a material of lower coefficient of linear expansion than that of the material used in the outer ring member is press fit around the outer peripheral surface of the outer ring member. Thus the amount of expansion of the inner diameter of the outer ring raceways formed on the inner periphery of the outer ring member can also be retained in a relatively lower value. The low expansion ring is fog for example of ceramic material etc.

In the case of the bearing device of the double row bearing, upon rising the temperature thereof, the sleeve outer ring is tend to expand also in the axial direction, and the spacing between the first and the second outer ring raceways is enlarged to displace the outer ring raceways relative to the balls of each rows so as to reduce the radial clearance. Thus the pre-load to be applied to the balls can be maintained in a suitable value.

Thus the radial clearance of the bearing device can be remained in an appropriate value and the accuracy of the rotation can also constantly be kept stable even if the temperature of the bearing device is varied. In this connection, the generation of the rotational run out and noises accompanied therewith can be suppressed.

In the bearing device having the balls of ceramic material, the durability of the balls is higher than the balls of steel so that the bearing device of longer service life can be obtained.

While particular embodiments of the present intention have been illustrated and described, it should be obvious to those skilled in the art that various changes and modifications can be made without departing from the spirit and scope of the invention.

What is claimed is:

1. A motor having a rotational member rotatably supported through a bearing device provided on a base member of the motor, said bearing device including inner and an outer rings and a plurality of balls interposed therebetween, said bearing device further including;
a low expansion He press fit around the outer periphery of the outer ring, wherein the low expansion member is made of a material lower in its coefficient of linear expansion than that employed for the outer ring.

2. A motor having a rotational member rotatably supported through a bearing device provided on a base member thereof, said bearing device further including;
a shaft, a cylindrical outer ring mar surrounding the shaft, a plurality of balls of the first and the second rows interposed between the shaft and the outer ring member and a low expansion member press fit around the outer periphery of the outer ring, wherein the low expansion member is made of a material lower in its coefficient of linear expansion than that employed for the outer ring.

3. A motor having a rotational member rotatably supported through a bearing device provided on a base member thereof, said bearing device further including;
a shaft to which an inner ring is fit slidably therearound, a cylindrical outer ring member surrounding the shaft, a plurality of balls of the first row interposed between the first inner ring raceway formed on the outer periphery of the inner ring and the first outer ring raceway formed on the inner periphery of the outer ring member, a plurality of balls of the second row interposed between the second inner ring raceway formed directly on the outer periphery of the shaft and the second outer ring raceway formed on the inner periphery of the outer ring member, and a low expansion ring press fit around the outer periphery of the outer ring, wherein the low expansion ring is made of a material lower in its coefficient of linear expansion than that employed for the outer ring, the inner ring is secured on the shaft with applying an appropriate amount of preload thereon.

4. A motor having a rotational member rotatably supported through a bearing device provided on a base member thereof, said bearing device further including;
a shaft, a cylindrical outer ring member surrounding the shaft, a plurality of balls of the first and the second rows interposed between the shaft and the outer ring member, and a low expansion member press fit around the outer periphery of the outer ring, wherein the low expansion member is made of a material lower in its coefficient of linear expansion than that employed for the outer ring, and wherein the shaft is secured on the base member to extend therefrom, and the central portion of the rotor or the rotational member is fit over the outer periphery of the outer ring member.

5. A motor having a rotational member rotatably supported through a bearing device provided on a base member thereof, said bearing dee further including;
a shaft to which an inner ring is fit slidably therearound, a cylindrical outer ring member surrounding the shaft, a plurality of balls of the first row interposed between the first inner ring raceway formed on the outer periphery of the inner ring and the first outer ring raceway formed on the inner periphery of the outer ring member, a plurality of balls of the second row interposed between the second inner ring raceway formed directly on the outer periphery of the shaft and the second outer ring raceway formed on the inner periphery of the outer ring member, and a low expansion ring press fit around the outer periphery of the outer ring, wherein the low expansion ring is made of a material lower in its coefficient of linear expansion than that employed for the outer ring, the inner ring is secured on the shaft with applying an appropriate amount of preload thereon, and wherein the shaft is secured on the base member to extend therefrom, and the central portion of the rotor or the rotational member is fit over the outer periphery of the outer ring member.

6. The bearing device according to any one of claims 1-5, characterized in that the balls are of ceramic material.

7. The bearing device according to any one of claim 1-5, characterized in that the low expansion member is of ceramic material.
